(19) United States
(12) Patent Application Publication
(10) Pub. No.: US 2026/0156222 A1
(43) Pub. Date: Jun. 4, 2026

(54) INFORMATION PROCESSING APPARATUS, IMAGE FORMING APPARATUS, AND INFORMATION PROCESSING SYSTEM

(71) Applicant: SHARP KABUSHIKI KAISHA, Osaka (JP)

(72) Inventor: MASANORI HAMAMOTO, Osaka (JP)

(21) Appl. No.: 19/353,879

(22) Filed: Oct. 9, 2025

(30) Foreign Application Priority Data
Oct. 10, 2024 (JP) 2024-178310

(51) Int. Cl. H04N 1/00

(52) U.S. Cl. CPC H04N 1/00973; H04N 2201/0094

(57) ABSTRACT

An information processing apparatus including a controller, and a communicator capable of communicating with a plurality of devices including a first device and a second device. The controller compares a model of the first device and a model of the second device with each other, determines whether a common setting item exists in both of the first device and setting information of the second device in common in a case where the first device and the second device are of models different from each other, and outputs information related to copying of a part or all of the setting information of the first device as the setting information of the second device based on a result of the determination.

### CROSS-REFERENCE TO RELATED APPLICATION

The present application claims priority from Japanese Application JP2024-178310, the content of which is hereby incorporated by reference into this application.

### BACKGROUND

### Field

The disclosure relates to an information processing apparatus and the like.

### Background Art

An administrator who manages a plurality of devices such as MFPs may desire to copy setting information applied to a certain device and apply the copied setting information to another device.

### SUMMARY

In the related art, copying of setting information of a device could be basically executed only when a copy source device and a copy destination device were of an identical model, and could not be executed when both were of different models.

A problem that the disclosure tries to solve is to facilitate management of setting information of a plurality of devices.

The disclosure provides an information processing apparatus including a controller, and a communicator allowed to communicate with a plurality of devices including a first device and a second device, wherein the controller compares a model of the first device and a model of the second device with each other, determines whether a common setting item exists in both of the first device and setting information of the second device in common in a case where the first device and the second device are different from each other in model, and outputs information related to copying a part or all of the setting information of the first device as the setting information of the second device based on a result of the determination.

Further, the disclosure provides an image forming apparatus including a controller, and a communicator allowed to communicate with another image forming apparatus, wherein the controller compares a model of the own image forming apparatus and a model of the other image forming apparatus with each other, determines whether a common setting item exists in both of the own image forming apparatus and setting information of the other image forming apparatus in common in a case where the own image forming apparatus and the other image forming apparatus are different from each other in model, and outputs information related to copying a part or all of the setting information of the own image forming apparatus as the setting information of the other image forming apparatus based on a result of the determination.

Additionally, the disclosure provides an information processing system including a client terminal, a server, and a plurality of image forming apparatuses including a first image forming apparatus and a second image forming apparatus, that are communicably connected to each other via a network, wherein the server compares a model of the first image forming apparatus and a model of the second image forming apparatus with each other, determines whether a common setting item exists in both of the first image forming apparatus and setting information of the second image forming apparatus in common in a case where the first image forming apparatus and the second image forming apparatus are different from each other in model, and outputs, to the client terminal, information related to copying a part or all of the setting information of the first image forming apparatus as the setting information of the second image forming apparatus based on a result of the determination.

Further, the disclosure provides a controlling method for an information processing apparatus including comparing a model of a communicable first device and a model of a communicable second device with each other, determining presence or absence of a common setting item included in both setting information of the first device and setting information of the second device in common in a case where the first device and the second device are different from each other in model, and outputting information related to copying a part or all of the setting information of the first device as the setting information of the second device based on a result of the determination.

### Advantageous Effects of Disclosure

According to the disclosure, it is possible to facilitate management of setting information of a plurality of devices.

### BRIEF DESCRIPTION OF THE DRAWINGS

FIG. 1 is a schematic conceptual diagram of a system according to a first embodiment of the disclosure.

FIG. 2 is a functional block diagram of a server according to the first embodiment of the disclosure.

FIG. 3 is a diagram for describing a software configuration of a controller of the server according to the first embodiment of the disclosure.

FIG. 4 is a diagram for describing a software configuration of a storage unit of the server according to the first embodiment of the disclosure.

FIG. 5 is a flowchart for describing a part of operation of the server according to the first embodiment of the disclosure.

FIG. 6 is a flowchart for describing another part of the operation of the server according to the first embodiment of the disclosure.

FIG. 7 is a conceptual schematic diagram for describing data processing when setting information is copied between MFPs of an identical model.

FIG. 8 is an example of a screen displayed on a client terminal when setting information is copied between MFPs of an identical model, and is an example of a screen for selecting a source device and a target device, in the first embodiment of the disclosure.

FIG. 9 is an example of a screen displayed on the client terminal when setting information is copied between MFPs of an identical model, and is an example of a screen displayed while a source device and a target device are compared regarding device information, in the first embodiment of the disclosure.

FIG. 10 is an example of a screen displayed on the client terminal when the setting information is copied between the MFPs of the identical model, and is an example of a screen that notifies that models and firmware versions of the source device and the target device match and asks a user whether to execute copying or not, in the first embodiment of the disclosure.

FIG. 11 is an example of a screen displayed on the client terminal when the setting information is copied between the MFPs of the identical model, and is an example of a screen that notifies that the firmware versions of the source device and the target device do not match and asks the user whether to execute copying or not, in the first embodiment of the disclosure.

FIG. 12 is a conceptual schematic diagram for describing copying of setting information between MFPs of different models.

FIG. 13 is a conceptual schematic diagram for describing data processing when setting information is copied between MFPs of different models.

FIG. 14 is an example of a screen displayed on the client terminal when setting information is copied between MFPs of different models, and is an example of a screen displayed when a source device and target devices are selected, in the first embodiment of the disclosure.

FIG. 15 is an example of a screen displayed on the client terminal when the setting information is copied between the MFPs of the different models, and is an example of a screen displayed when models and firmware versions are compared between the source device and the target devices, in the first embodiment of the disclosure.

FIG. 16 is an example of a screen displayed on the client terminal when the setting information is copied between the MFPs of the different models, and is an example of a screen for notifying the user that there is a target device of a model different from that of the source device and thus both the devices are searched and compared regarding setting information, in the first embodiment of the disclosure.

FIG. 17 is an example of a screen displayed on the client terminal when the setting information is copied between the MFPs of the different models, and is an example of a screen displaying a result of the comparison of the models and the firmware versions between the source device and the target devices, in the first embodiment of the disclosure.

FIG. 18 is an example of a screen displayed on the client terminal when the setting information is copied between the MFPs of the different models, and is an example of a screen for notifying the user of, among setting items of setting information, a setting item not to be copied, in the first embodiment of the disclosure.

FIG. 19 is an example of a screen displayed on the client terminal when the setting information is copied between the MFPs of the different models, and is an example of a state in which the target devices are selected, in the first embodiment of the disclosure.

FIG. 20 is an example of a screen displayed on the client terminal when the setting information is copied between the MFPs of the different models, and is an example of a screen for notifying the user that the selected target devices include a target device that is not completely compatible with the source device, in the first embodiment of the disclosure.

FIG. 21 is an example of a screen displayed on the client terminal when the setting information is copied between the MFPs of the different models, and is an example of a screen for notifying the user that the copying of the setting information is completed, in the first embodiment of the disclosure.

FIG. 22 is a conceptual schematic diagram for describing a failure in copying setting information.

FIG. 23 is a conceptual schematic diagram for describing data processing when setting information is copied between MFPs of different models, and further, whether copying of the setting information succeeds or not is checked.

FIG. 24 is a flowchart for describing a part of operation of a server according to a second embodiment of the disclosure.

FIG. 25 is a diagram for describing a configuration of a controller of a server according to a third embodiment of the disclosure.

FIG. 26 is a diagram for describing a configuration of a storage unit of the server according to the third embodiment of the disclosure.

FIG. 27 is a flowchart for describing a part of operation of the server according to the third embodiment of the disclosure.

FIG. 28 is a flowchart for describing another part of the operation of the server according to the third embodiment of the disclosure.

FIG. 29 is an example of a screen displayed on the client terminal, and is an example of a screen for selecting a source device, in the third embodiment of the disclosure.

FIG. 30 is an example of a screen displayed on the client terminal, and is an example of a screen displayed when device information of the source device and device information of each MFP in a target table are compared, in the third embodiment of the disclosure.

FIG. 31 is an example of a screen displayed on the client terminal, and is an example of a screen for notifying the user that candidate devices for a target device include a candidate device not completely compatible with the source device, in the third embodiment of the disclosure.

FIG. 32 is an example of a screen displayed on the client terminal, and is an example of a screen for notifying the user that the candidate devices for the target device include a candidate device not completely compatible with the source device, in the third embodiment of the disclosure.

### DESCRIPTION OF EMBODIMENTS

### 1. First Embodiment

### 1.1 System Overview

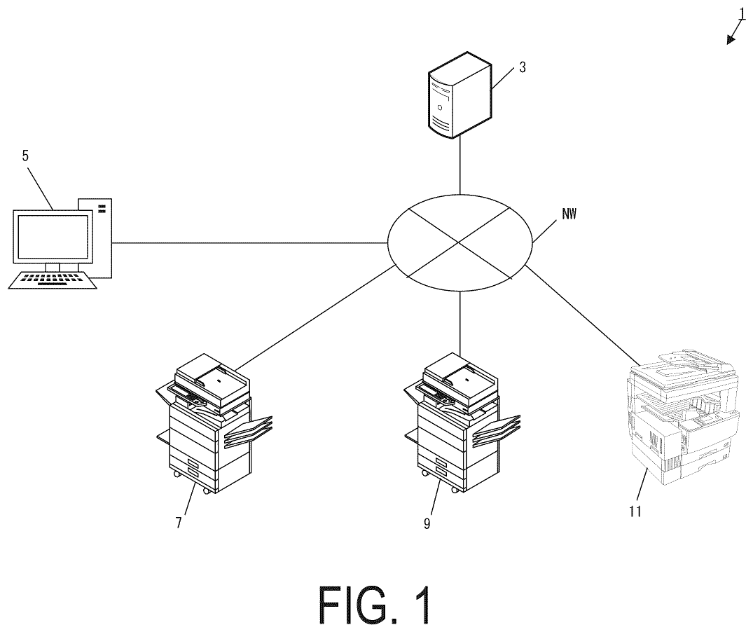

FIG. 1 is a schematic conceptual diagram of a system 1 according to a first embodiment of the disclosure. The system 1 includes a server 3, a client terminal 5, and Multi-Function Printers/Peripherals (MFPs) 7, 9, and 11, which are connected to each other via a network NW so as to enable data communication.

### 1.2 Hardware Configuration

The server 3 is an information processing apparatus including a data communication interface. The client terminal 5 is also an information processing apparatus including a data communication interface, and is specifically, for example, a desktop computer, a laptop computer, a workstation, a tablet, a smartphone, or the like.

Each of the MFPs 7, 9, and 11 is the multi-function printer, and typically has a copy function, an image scanner function, a facsimile function, and a printer function. The MFPs 7, 9, and 11 may further have other functions, and for example, may have an email sending and receiving function, a file server function, and the like. The MFPs 7, 9, and 11 are a mixture of different models. As illustrated in FIG. 1, the MFPs 7 and 9 are of an identical model, while the MFP 11 is of a model different from that of the MFPs 7 and 9.

The network NW is, for example, a Local Area Network (LAN), a Wide Area Network (WAN), or the Internet. The network NW may include a mobile communication network.

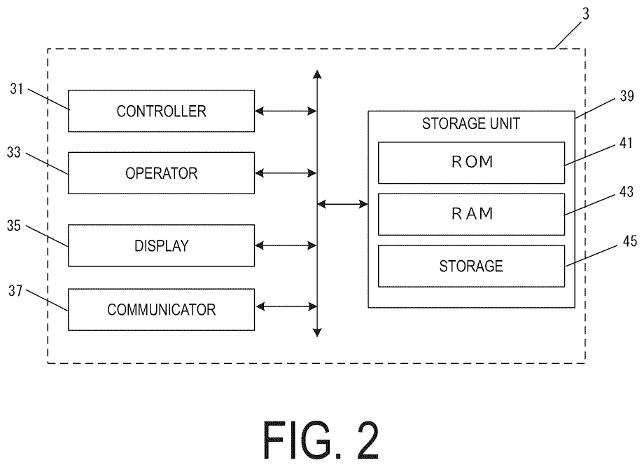

FIG. 2 is a functional block diagram of the server 3 according to the first embodiment of the disclosure. The server 3 includes a controller 31, an operator 33, a display 35, a communicator 37, and a storage unit 39. The storage unit 39 includes a Read Only Memory (ROM) 41, a Random Access Memory (RAM) 43, and a storage 45.

The controller 31 controls an entire image forming apparatus. The controller 31 includes one or more control devices or one or more control circuits, and includes, for example, a Central Processing Unit (CPU), a System on a Chip (SoC) that is a processor that executes various types of arithmetic processing, or the like. Further, the controller 31 can enable each function by loading a program stored in the storage 45 of the storage unit 39 into the RAM 43 and executing the program.

The operator 33 receives an operation input from a user. For example, the operator 33 includes hardware keys and/or software keys. The operator 33 can be configured as a touch panel that allows input via the display 35. When the operator 33 is configured as the touch panel, the operator 33 can detect the user's touch, tap, swipe operation, or the like with respect to an object displayed via the display 35, and can acquire a coordinate position, pressure-sensitive information, or the like of touch panel information. In this case, an input scheme for the touch panel can be a general input scheme such as a resistive film scheme, an infrared scheme, an electromagnetic induction scheme, or a capacitive scheme.

The display 35 displays images and text. For example, the display 35 is configured of a Liquid Crystal Display (LCD) or an organic Electro-Luminescence (EL) panel. The display 35 may be a standalone display device, or may further include an externally connected display device.

The communicator 37 is connected to the network NW. For example, the communicator 37 is configured of an interface that can be connected to a wired Local Area Network (LAN), a wireless LAN, or a Long Term Evolution (LTE) network. The communicator 37 is connected to the network NW for connection to another device or an external network. In addition, the communicator 37 may be an interface for short-distance wireless communication such as Near Field Communication (NFC) or Bluetooth (trade name).

The storage unit 39 stores various programs and various types of data necessary for operation of the server 3. The ROM 41 is a read-only, non-writable storage device. The RAM 43 is an area (main storage area) used for executing a program, and is a recording device that enables temporary storage, such as a Dynamic Random Access Memory (DRAM). The storage 45 is an area (auxiliary storage area) for storing programs and data, and is a non-transitory recording device. The storage 45 is, for example, a Solid State Drive (SSD) constituted by a semiconductor memory or a Hard Disk Drive (HDD) constituted by a magnetic disk. The storage unit 39 may further include an area used for other applications such as an area used for a cache.

### 1.3 Software Configuration

### 1.3.1 Configuration of Controller

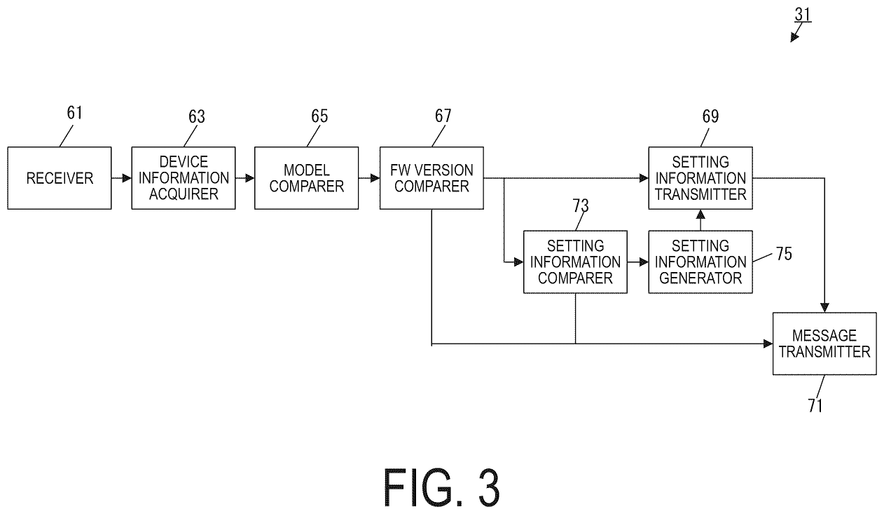

FIG. 3 is a diagram for describing a software configuration of the controller 31 of the server 3 according to the first embodiment of the disclosure. The controller 31 functions as a receiver 61, a device information acquirer 63, a model comparer 65, a firmware (FW) version comparer 67, a setting information transmitter 69, a setting information comparer 73, a setting information generator 75, and a message transmitter 71.

The receiver 61 receives an instruction from the client terminal 5 via the network NW and the communicator 37.

The device information acquirer 63 receives device information from each of the MFPs 7, 9, and 11 via the network NW and the communicator 37. The device information includes identification information for identifying the MFP, model information indicating a model number of the MFP, firmware version (hereinafter referred to as an FW version) information of the MFP, and setting information of the MFP. In the device information, the identification information, the model information, the FW version information, and the setting information are associated with each other. The device information acquirer 63 stores the acquired device information in a device information storage unit 91 (described below) corresponding to the device.

The setting information is a set of values of setting items that are referred to when the MFP executes various functions. The setting information includes, for example, a setting item indicating in what format print data is printed. The setting items include, for example, color printing, monochrome printing, single-sided printing, double-sided printing, and stapling, punching, and paper folding after printing, and “YES” (1) or “NO” (0) is set as a setting value for each of these setting items. In addition, the setting items may include, in addition to “YES”/“NO”, a setting item for which a numerical value referred to in a case of “YES” is included in a setting value. For example, a setting item “page aggregation (the number of pages to be printed on one side of a print sheet)” may include a numerical value, in addition to “YES”/“NO”, indicating the number of pages to be printed on one side of a print sheet as a setting value.

The model comparer 65 determines whether models (model numbers) of two MFPs are identical or not based on model information. Note that two MFPs being of an identical model includes a case where the two MFPs have an identical model name and a case where the two MFPs have different model names but an identical combination of setting items included in setting information. Hereinafter, two MFPs having the latter relationship are described as belonging to an identical series. The model information includes identification information for identifying a series to which the MFP belongs. The FW version comparer determines whether firmware versions of two MFPs of an identical model are identical or not based on the FW version information. The setting information transmitter 69 transmits setting information to any one of the MFPs 7, 9, and 11 via the communicator 37 and the network NW. The message transmitter 71 transmits a message to the client terminal 5 via the communicator 37 and the network NW. The setting information comparer 73 compares two MFPs with each other regarding setting items included in setting information, and extracts setting items in common in the setting information of the two MFPs. The setting information generator 75 generates setting information based on output of the setting information comparer 73.

### 1.3.2 Configuration of Storage Unit

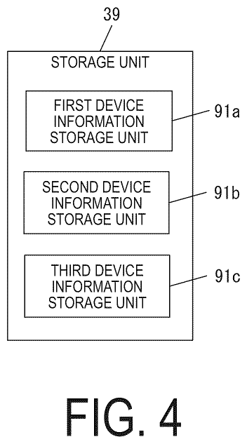

FIG. 4 is a diagram for describing a software configuration of the storage unit 39 of the server 3 according to the first embodiment of the disclosure. The storage unit 39 includes a first device information storage unit 91a, a second device information storage unit 91b, and a third device information storage unit 91c. The first device information storage unit 91a, the second device information storage unit 91b, and the third device information storage unit 91c are also collectively referred to as a device information storage unit 91.

The first device information storage unit 91a, the second device information storage unit 91b, and the third device information storage unit 91c are areas that store device information of the MFPs 7, 9, and 11 in order, respectively. Therefore, the first device information storage unit 91a stores the identification information, the model information, the FW version, and the setting information of the MFP 7. The same applies to the second device information storage unit 91b and the third device information storage unit 91c.

The storage unit 39 may include device information storage units corresponding to the number of MFPs included in the system 1. In the first embodiment, since the system 1 includes the three MFPs 7, 9, and 11, the storage unit 39 includes the three device information storage units.

### 1.4 Operation

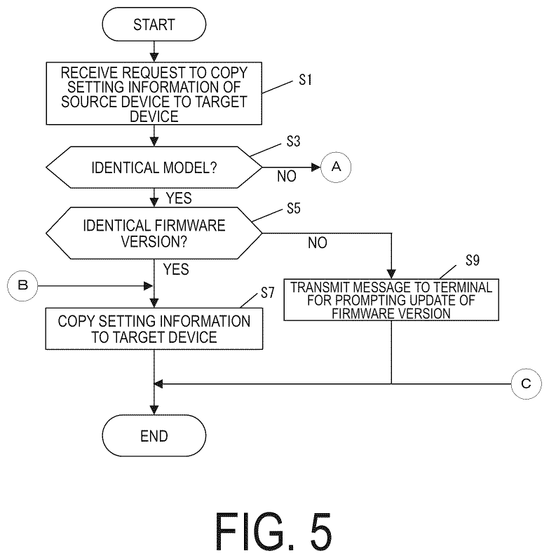

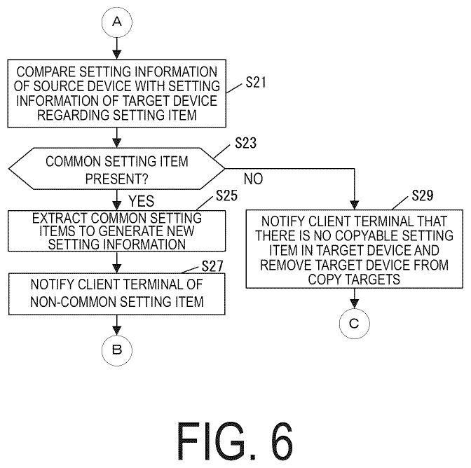

FIG. 5 is a flowchart for describing a part of operation of the server 3 according to the first embodiment of the disclosure. FIG. 6 is a flowchart for describing another part of the operation of the server according to the first embodiment of the disclosure. Note that although it is preferable that the following processing be appropriately executed by any of the configurations described in FIG. 3, for convenience of description, the following processing will be described as being executed by the controller 31.

In advance of the operation in FIG. 5, the controller 31 communicates with the MFPs 7, 9, and 11 via the network NW using the communicator 37, acquires the device information of each MFP, and stores the device information in the storage unit 39. The device information includes the model number information, the FW version information, and the setting information of the MFP. The model number information is information indicating the model number of the MFP. The FW version information is information indicating a current firmware version of the MFP. The setting information is a collection of setting values of various setting items of the MFP. The setting information may be written in a markup language such as an eXtensible Markup Language (XML) or a Hyper-Text Markup Language (HTML), or a data description language such as JavaScript Object Notation (JSON).

The communicator 37 receives a request to copy setting information from the client terminal 5 via the network NW (step 1). Hereinafter, a device (MFP) corresponding to setting information of a copy source is referred to as a source device, and a device (MFP) corresponding to setting information of a copy destination is referred to as a target device. Note that the source device may be referred to as a first device, and the target device may be referred to as a second device. The request to copy setting information includes identification information of the source device and identification information of the target device.

The controller 31 acquires model number information of the source device and model number information of the target device from the storage unit 39 and compares them with each other, thereby determining whether the source device and the target device are of an identical model or not (step 3). The source device is any one of the MFPs 7, 9, and 11, and the target device is any one of the MFPs 7, 9, and 11 other than the source device.

The controller 31 determines whether the source device and the target device are of an identical model or not (step 3). The controller 31 may request device information from the MFPs designated as the source device and the target device via the communicator 37 and the network NW, and may determine whether the MFPs are of an identical model or not based on model information of received device information. Alternatively, in advance of step 1, the controller 31 may request device information from each MFP in the system 1 via the communicator 37 and the network NW, and store received device information of the MFP in the device information storage unit 91 corresponding to the MFP. In this case, the controller 31 may read the device information of each of the source device and the target device from the device information storage units 91 corresponding thereto, and determine whether the devices are of an identical model or not.

When the source device and the target device are of an identical model (step 3, YES), the controller 31 acquires FW version information of each of the source device and the target device from the storage unit 39 for comparison with each other, thereby determining whether firmware versions of the source device and the target device are identical or not (step 5).

When the firmware versions of the source device and the target device are identical (step 5, YES), the controller 31 reads setting information of the source device from the storage unit 39, transmits the setting information of the source device to the target device via the network NW using the communicator 37, and transmits a control signal requesting the target device to update setting information of the own device with the transmitted setting information (step 7). The target device receiving the control signal overwrites the setting information of the own device with the setting information (that is, the setting information of the source device) received from the server 3 according to the control signal.

When it is determined in step 5 that the firmware versions are different from each other (step 5, NO), the controller 31 transmits a message prompting update of firmware of the source device or the target device to the client terminal 5 (step 9). The client terminal 5 receiving the message displays the message on the screen of the client terminal. The user who sees the message may update the firmware of the MFP having an older firmware version between the MFPs designated as the source device and the target device, and then may make the request of step 1 again using the client terminal 5.

Here, the setting information of the source device is referred to as setting information Ss, and the setting information of the target device is referred to as setting information St. When it is determined in step 3 that the devices are not of an identical model (step 3, NO), the controller 31 compares setting items included in the setting information Ss and setting items included in the setting information St with each other, and classifies the setting items included in the setting information Ss into two types of common setting items and non-common setting items. The common setting item is a setting item included in the setting information of the source device and the setting information of the target device in common. The non-common setting item is a setting item that is included only in the setting information of the source device and is not included in the setting information of the target device. The controller 31 extracts the common setting items from the setting information Ss (step 21).

When there are the common setting items (step 23, YES), the controller 31 extracts the common setting item and a setting value thereof from the setting information Ss. The controller 31 generates new setting information Su including the extracted common setting item and the setting value thereof (step 25). The configuration information Su is a subset of the setting information Ss of the source device.

Next, the controller 31 notifies the client terminal 5 of the non-common setting item via the network NW using the communicator 37, and transmits a control signal for requesting the client terminal 5 to display the notified non-common setting item on the display device of the client terminal 5 (step 27).

Next, the controller 31 transmits the setting information Su to the target device via the network NW using the communicator 37, and transmits a control signal for requesting the target device to update the setting information of the own device with the transmitted setting information Su (step 7).

In step 23, when there is no common setting item (step 23, NO), the controller 31 transmits a message indicating that there is no setting item that can be copied to the target device in the setting information Ss of the source device to the client terminal 5 via the network NW using the communicator 37. At this time, the controller 31 may store a fact that the target device does not serve as a copy target of the setting information Ss of the source device as copy restriction information in the storage unit 39. In this case, when step 1 is executed thereafter, the controller 31 may determine whether the setting information of the source device for which the request is received is to be copied to the setting information of the target device or not, based on the copy restriction information. When it is determined that the target device does not serve as a copy target, the controller 31 may transmit a message indicating that copying cannot be executed to the client terminal 5 via the network NW using the communicator 37, and may interrupt the processing.

### 1.5 Operation Example

### 1.5.1 Operation Example in Case Where Source Device and Target Device are of Identical Model

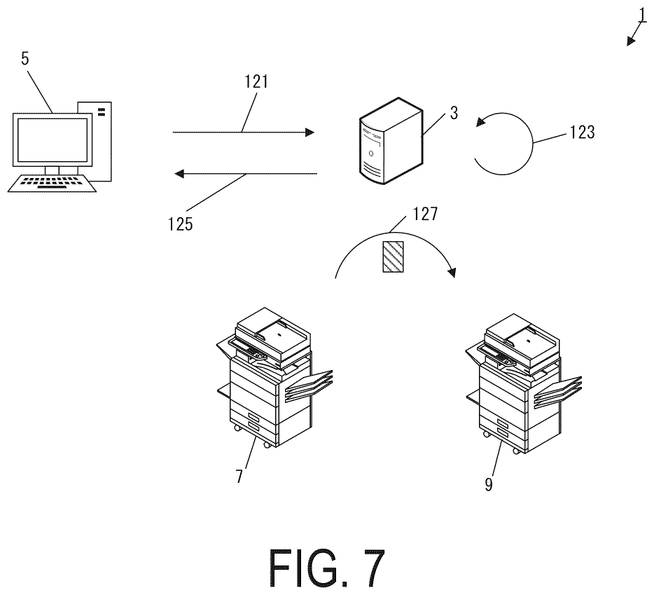

FIG. 7 is a conceptual schematic diagram for describing data processing when setting information is copied between MFPs of an identical model. Here, the setting information of the MFP 7 is copied and is used to update the setting information of the MFP 9 being of the identical model to that of the MFP 7.

When the client terminal 5 requests the server 3 to designate the MFP 7 as a source device and the MFP 9 as a target device and overwrite the setting information of the target device using a copy of the setting information of the source device (an arrow 121), the controller 31 of the server 3 determines whether the source device and the target device are of an identical model or not based on the model information stored in the device information storage units 91, and in a case of an identical model, further determines whether firmware versions of the source device and target device are identical or not based on the FW version information stored in the device information storage units 91 (an arrow 123).

When the firmware versions of the source device and the target device are different from each other, the controller 31 transmits a message for prompting firmware version update to the client terminal 5 via the communicator 37 and the network NW (an arrow 125).

When the source device and target devices are of the identical model and the firmware versions are identical, the controller 31 copies the setting information of the source device (MFP 7) stored in the device information storage unit 91 and transmits the copied setting information to the target device (MFP 9) together with a control signal instructing to update the setting information (an arrow 127).

### 1.5.2 Screen Example in Case Where Source Device and Target Device are of Identical Model

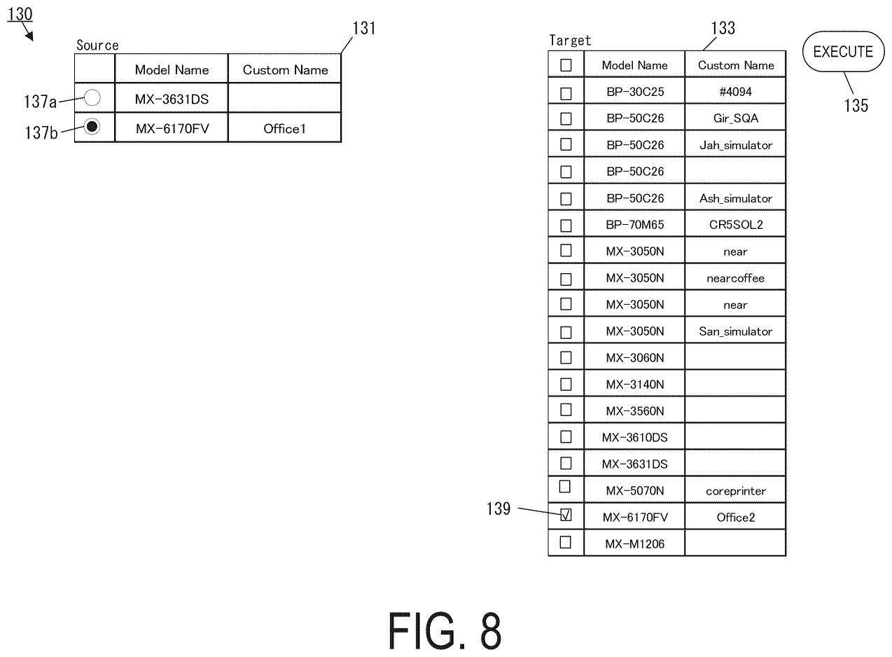

A screen 130 in FIG. 8 is an example of a screen displayed on the client terminal when setting information is copied between MFPs of an identical model, and is an example of a screen for selecting a source device and a target device, in the first embodiment of the disclosure.

A source table 131 is a table in which candidates of a source device are displayed. The source table 131 includes a Model Name field for storing a model name of an MFP and a Custom Name field for storing a custom name of the MFP. Respective rows of the source table 131 include radio buttons 137a and 137b each indicating that an MFP in the row is selected as a source device.

A target table 133 is a table in which candidates of a target device are displayed. The target table 133 includes a Model Name field and a Custom Name field, similarly to the source table 131. Respective rows of the target table 133 include check boxes, such as a check box 139, each indicating that an MFP in the row is selected as a target device.

An EXECUTE button 135 is a button for executing copying of setting information based on selections in the source table 131 and the target table 133. In response to an operation of the EXECUTE button 135, the screen 130 transitions to a screen 140 described below. When the EXECUTE button 135 is operated on the screen in FIG. 8, an MFP indicated by the radio button 137b and having a Model Name of MX-6170FV and a Custom Name of Office1 is selected as a source device, and an MFP indicated by the check box 139 and having a Model Name of MX-6170FV and a Custom Name of Office2 is selected as a target device.

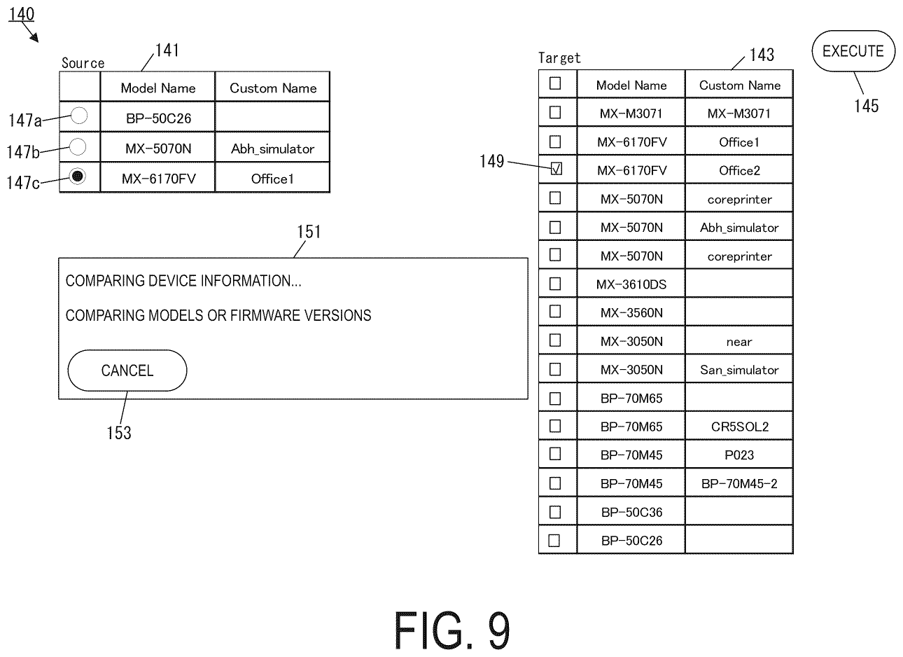

A screen 140 in FIG. 9 is an example of a screen displayed on the client terminal when setting information is copied between MFPs of an identical model, and is an example of a screen for selecting a source device and a target device, in the first embodiment of the disclosure. The screen 140 includes a source table 141 and a target table 143 corresponding to the source table 131, the target table 133, and the EXECUTE button 135, respectively.

The source table 141 includes radio buttons 147a, 147b, and 147c, and an MFP corresponding to the radio button 147c is in a state of being selected as a source device. The target table 143 includes check boxes, and an MFP corresponding to a check box 149 is in a state of being selected as a target device.

The screen 140 further includes a dialog 151 and a CANCEL button 153. In the dialog 151, a message notifying the user that a comparison of device information is being executed between the source device and the target device is displayed. The CANCEL button 153 is a button for canceling the comparison of the device information being executed.

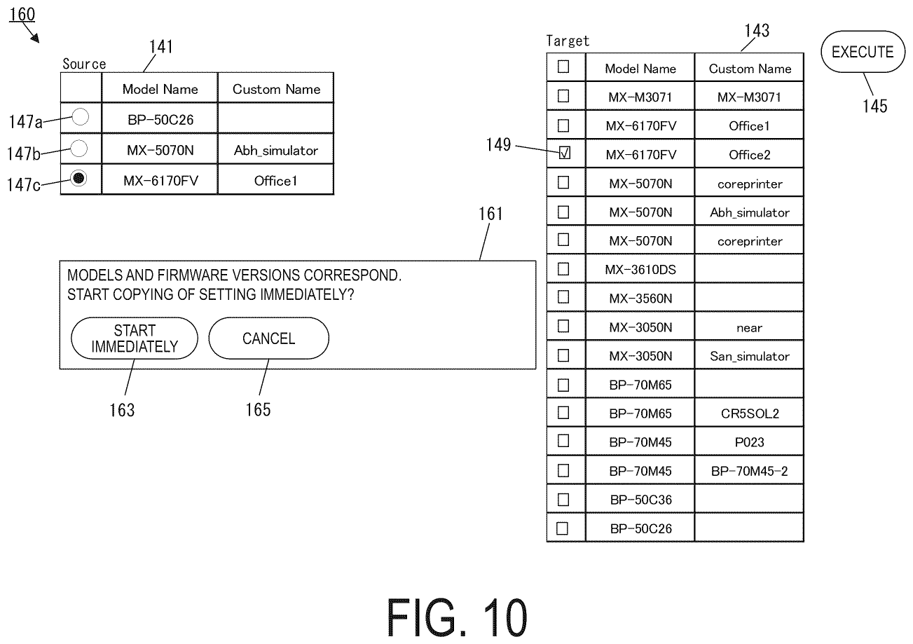

A screen 160 in FIG. 10 is an example of a screen displayed on the client terminal when the setting information is copied between the MFPs of the identical model in the first embodiment of the disclosure. The screen 160 is a screen, as a result of comparing the device information between the source device and the target device, displayed when both models and FW versions match.

The screen 160 is obtained by replacing the dialog 151 in the screen 140 with a dialog 161. On the dialog 161, a message is displayed that notifies that the models and the firmware versions of the source device and target device match, and asks the user whether to execute copying or not.

The screen 160 further includes a START IMMEDIATELY button 163 and a CANCEL button 165. The START IMMEDIATELY button 163 is a button for instructing the controller 31 to immediately start copying of the setting information. The CANCEL button 165 is a button for canceling the copying of the setting information.

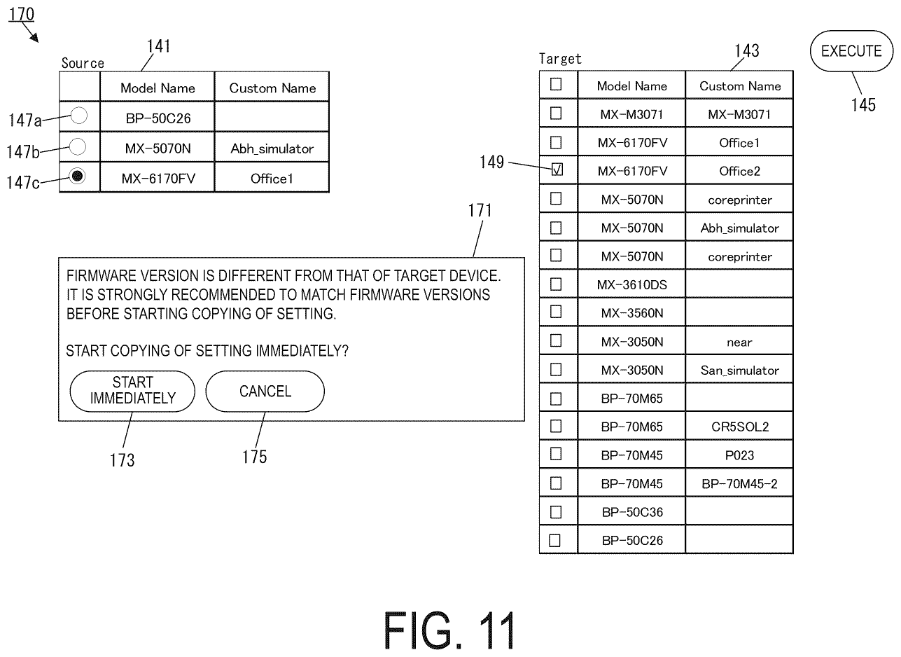

A screen 170 in FIG. 11 is an example of a screen displayed on the client terminal when the setting information is copied between the MFPs of the identical model in the first embodiment of the disclosure. The screen 170 is a screen, as a result of comparing the device information between the source device and the target device, displayed when the models match but the FW versions do not match.

The screen 170 is obtained by replacing the dialog 161 in the screen 160 with a dialog 171. On the dialog 171, a message is displayed that notifies that the firmware versions of the source device and target device do not match, and asks the user whether to execute copying or not.

The screen 170 further includes a START IMMEDIATELY button 173 and a CANCEL button 175. The START IMMEDIATELY button 173 is a button for instructing the controller 31 to immediately start copying of the setting information (although the firmware versions do not match). The CANCEL button 175 is a button for canceling the copying of the setting information.

### 1.5.3 Operation Example in Case Where Source Device and Target Device are of Different Models

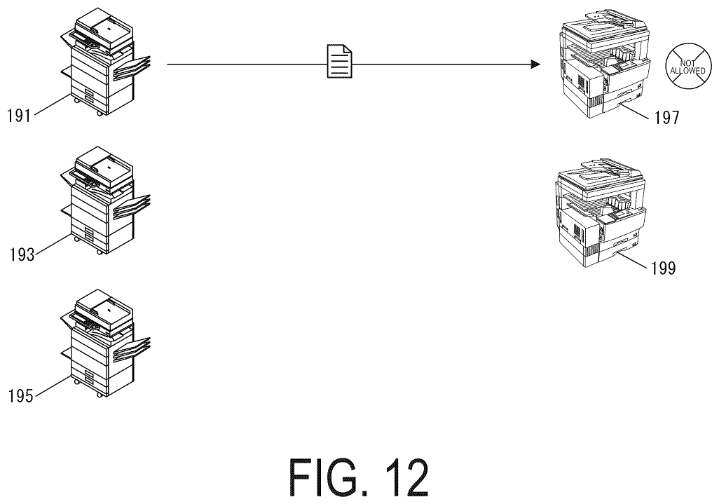

FIG. 12 is a conceptual schematic diagram for describing copying of setting information between MFPs of different models. MFPs 191, 193, and 195 are of models identical to each other. MFPs 197 and 199 are of models identical to each other. However, the MFPs 191, 193, and 195 and the MFPs 197 and 199 are of the models different from each other. In general, in a case of different models, contents of setting information are different from each other, and therefore, as illustrated in FIG. 12, for example, setting information of the MFP 191 cannot be copied as setting information of the MFP 197. However, in the disclosure, as described below, setting information can be copied even between different models under a certain condition.

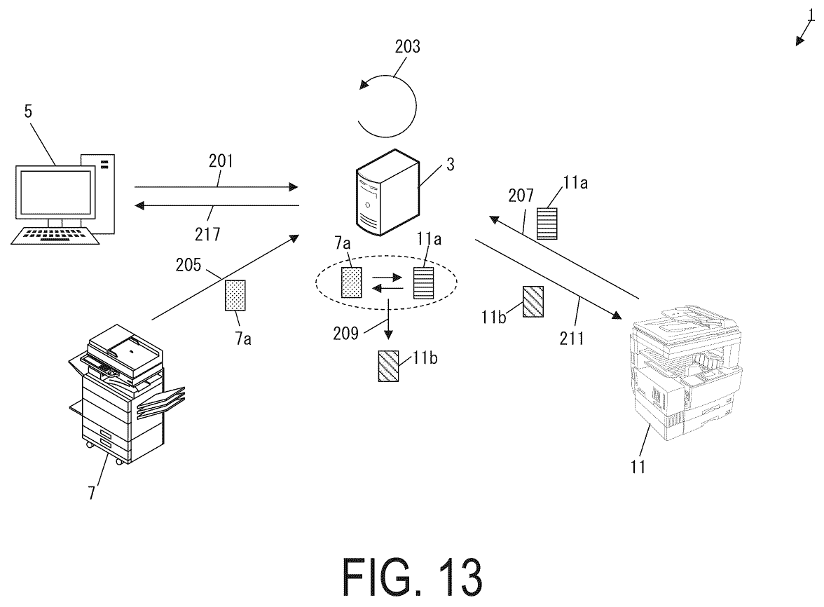

FIG. 13 is a conceptual schematic diagram for describing data processing when setting information is copied between MFPs of different models. The MFP 7 and the MFP 11 are of the models different from each other. The client terminal 5 requests the server 3 to copy, with the MFP 7 as a source device and the MFP 11 as a target device, setting information of the source device as setting information of the target device (an arrow 201, corresponding to step 1 in FIG. 5). When the request is received via the network NW and the communicator 37 in the server 3, the controller 31 determines whether the source device and the target device are of an identical model or not based on the model information stored in the device information storage units 91 (an arrow 203, corresponding to step 3 in FIG. 5). Here, the source device (MFP 7) and the target device (MFP 11) are of the models different from each other. At this time, the controller 31 acquires setting information 7a from the source device (an arrow 205) and acquires setting information 11a from the target device (an arrow 207). The controller 31 extracts setting items and setting values thereof included in the setting information 11a of the target device from the setting information 7a of the source device, and generates new setting information 11b including the extracted setting items and setting values (an arrow 209, corresponding to step 25 in FIG. 6). The controller 31 transmits the setting information 11b and an instruction to update the setting information to the target device via the communicator 37 and the network NW (an arrow 211). The target device MFP 11 being the target device that receives the instruction and the setting information 11b updates the own setting information from the setting information 11a to the setting information 11b. Further, the controller 31 also transmits a message related to a result of the copying to the client terminal 5 via the communicator 37 and the network NW (an arrow 217).

Generally, setting information of an MFP includes a setting value of each setting item. When two MFPs are of models identical to each other, setting items included in setting information are common. Therefore, setting information of a certain MFP can be copied to use as it is as setting information of another MFP of a model identical to that of the certain MFP.

On the other hand, when two MFPs are of models different from each other, setting items included in setting information of the MFPs are different from each other. Therefore, in principle, setting information of a certain MFP cannot be copied to use as it is as setting information of another MFP of a model different from that of the certain MFP. However, even among MFPs of different models, some of setting items included in setting information of the MFPs may be common.

For example, it is assumed that a certain manufacturer manufactures an MFP (A), and an MFP (B) as a version of the MFP (A), which is obtained by adding a function to the MFP (A). At this time, setting information of the MFP (B) may include a setting item related to the added function in addition to setting items included in setting information of the MFP (A). In such a case, a part of the setting information can be copied between the MFP (A) and the MFP (B). A setting value of a setting item included in the setting information of the MFP (A) can be copied as it is as a setting value of a corresponding setting item of the MFP (B). On the other hand, a setting value of a setting item included in the setting information of the MFP (B) can be copied as a setting value of a corresponding setting item of the MFP (A), except for a setting value of a setting item related to the function added to the MFP (B).

### 1.5.4 Screen Example in Case Where Source Device and Target Device are of Different Models

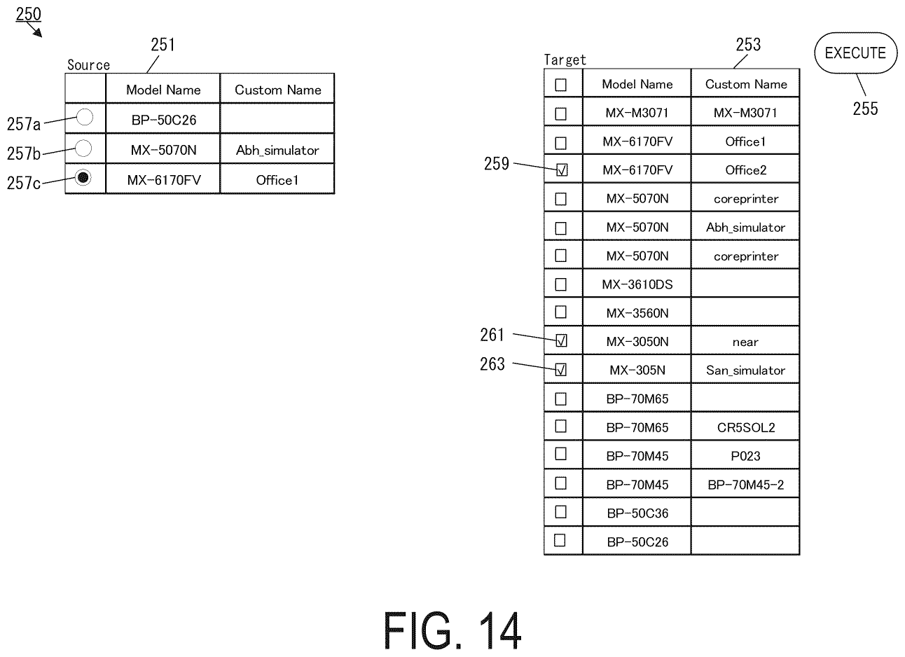

A screen 250 in FIG. 14 is an example of a screen displayed on the client terminal when setting information is copied between MFPs of different models, and is an example of a screen displayed when a source device and target devices are selected, in the first embodiment of the disclosure.

The screen 250 includes a source table 251, a target table 253, and an EXECUTE button 255, and the source table 251 includes radio buttons 257a, 257b, and 257c. The target table 253 includes check boxes 259 and 261. For the source table 251, the target table 253, the EXECUTE button 255, the radio buttons 257a, 257b, 257c, and the check boxes 259 and 261, refer to the description of the source table 131, the target table 133, the EXECUTE button 135, the radio buttons 137a, 137b, and the check boxes 139 in FIG. 8 described above.

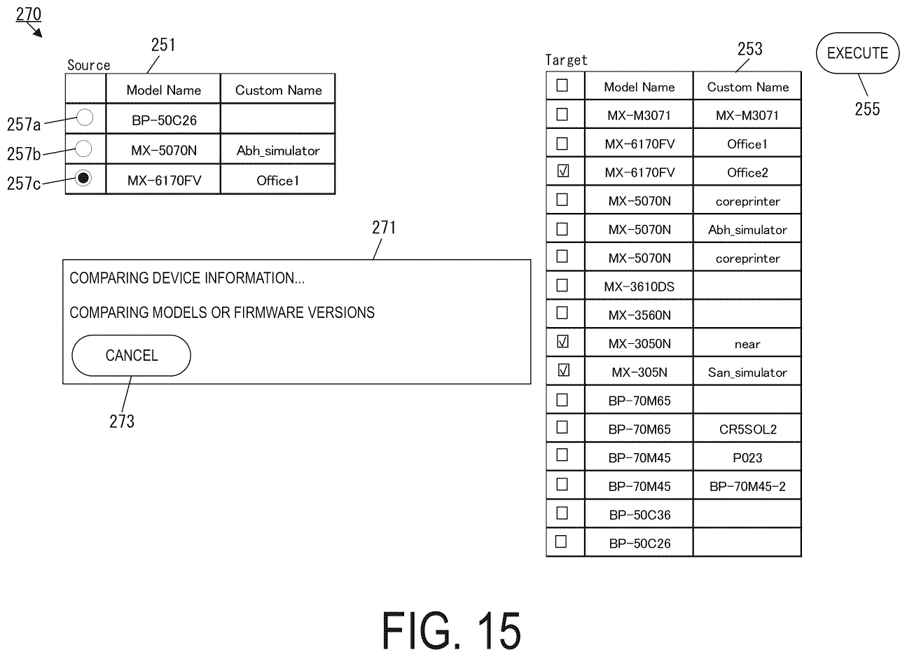

A screen 270 in FIG. 15 is an example of a screen displayed on the client terminal when the setting information is copied between the MFPs of the different models, and is an example of a screen displayed when models and firmware versions are compared between the source device and the target devices, in the first embodiment of the disclosure. The screen 270 includes a dialog 271 and a CANCEL button 273 in addition to the configuration of the screen 250. The dialog 271 displays a message indicating that a comparison of device information is being executed. The CANCEL button 273 is a button for interrupting the comparison of the device information.

In the screen 270, a model name of an MFP selected as a source device in the source table 251 is MX-6170FV. In the target table 253, three MFPs are selected as target devices, and respective model names are MX-6170FV, MX-3050N, and MX-305N. Among the three MFPs being the target devices, one MFP has an identical model name, and the other two MFPs have non-identical model names.

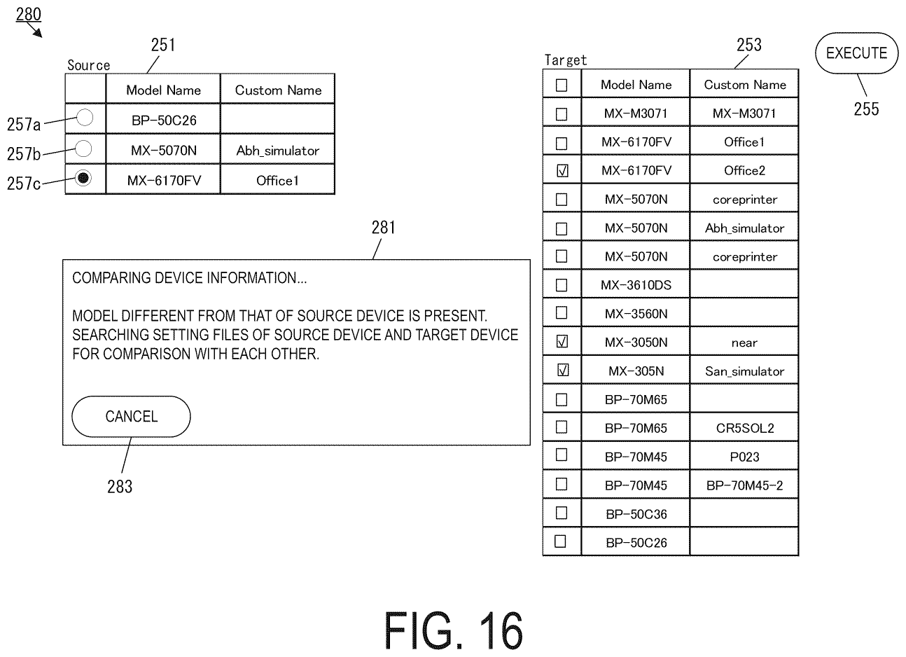

A screen 280 in FIG. 16 is an example of a screen displayed on the client terminal when the setting information is copied between the MFPs of the different models, and is an example of a screen for notifying the user that there is a target device of a model different from that of the source device and thus both the devices are searched and compared regarding setting information, in the first embodiment of the disclosure.

The screen 280 is a screen displayed after the screen 270. The screen 280 is obtained by replacing the dialog 271 in the screen 270 with a dialog 281. The dialog 281 includes a CANCEL button 283. The dialog 281 displays a message indicating that the target devices include an MFP of a model different from that of the source device. The CANCEL button 283 is a button for interrupting the comparison of the device information.

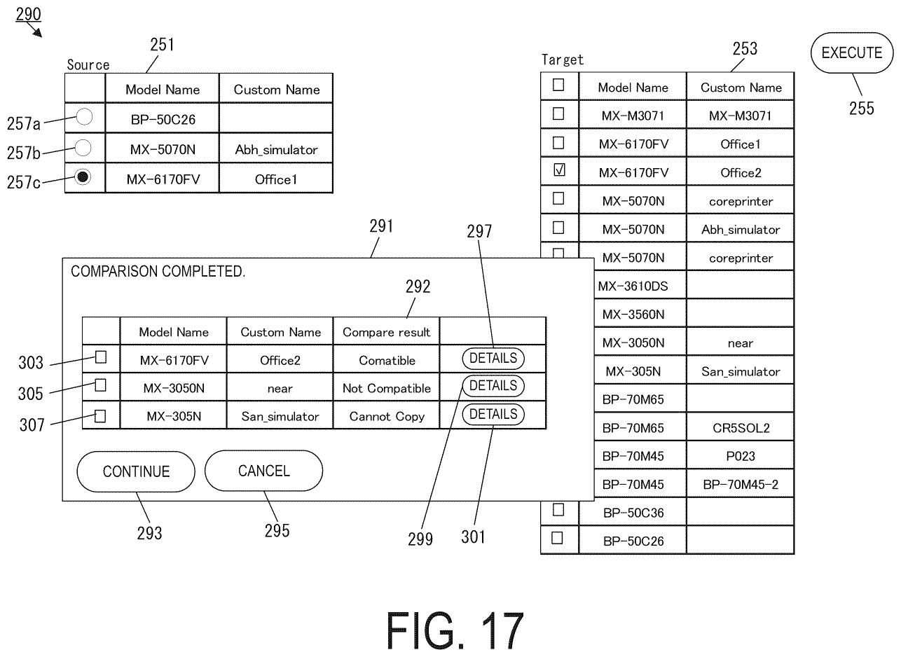

A screen 290 in FIG. 17 is an example of a screen displayed on the client terminal 5 when the setting information is copied between the MFPs of the different models, and is an example of a screen displaying a result of the comparison of the models and the firmware versions between the source device and the target devices, in the first embodiment of the disclosure.

The screen 290 is a screen displayed after the screen 280. The screen 290 is obtained by replacing the dialog 281 in the screen 280 with a dialog 291. The dialog 291 includes a comparison result table 292, a CONTINUE button 293, and a CANCEL button 295. The comparison result table 292 is a table in which the results of the comparison between the setting information of the source device and the setting information of the target devices are summarized. Each row in the comparison result table 292 includes a check box, a model name (Model Name), a custom name (Custom Name), a comparison result (Comparison Result), and a DETAIL button.

Each of check boxes 303, 305, and 307 indicates that copying based on detailed information of the source device is to be executed to an MFP in a row having a checked box. A comparison result “Compatible” in a row of the check box 303 indicates that the target device (model name: MX-6170FV) in the row is an MFP of an identical model to that of the source device (model name: MX-6170FV) and is an MFP to which the detailed information of the source device (model name: MX-6170FV) can be copied. Note that not only when the model names are identical, but also when combinations of setting items included in the setting information are identical, the models are determined to be identical (identical series). In order to execute this determination, for each MFP described in the source table 251 and the target table 292, identification information for specifying a series of own model is preferably stored in a storage device. A comparison result “Not Compatible” in a row of the check box 305 indicates that the target device (model name MX-3050N) in the row is of a model different from that of the source device (model name MX-6170FV) and is an MFP to which a part of the setting information of the source device can be copied. A comparison result “Cannot Copy” in a row of the check box 307 indicates that the target device (model name: MX-305N) in the row is of a model different from that of the source device (model name: MX-6170FV) and is an MFP to which even a part of the setting information of the source device cannot be copied.

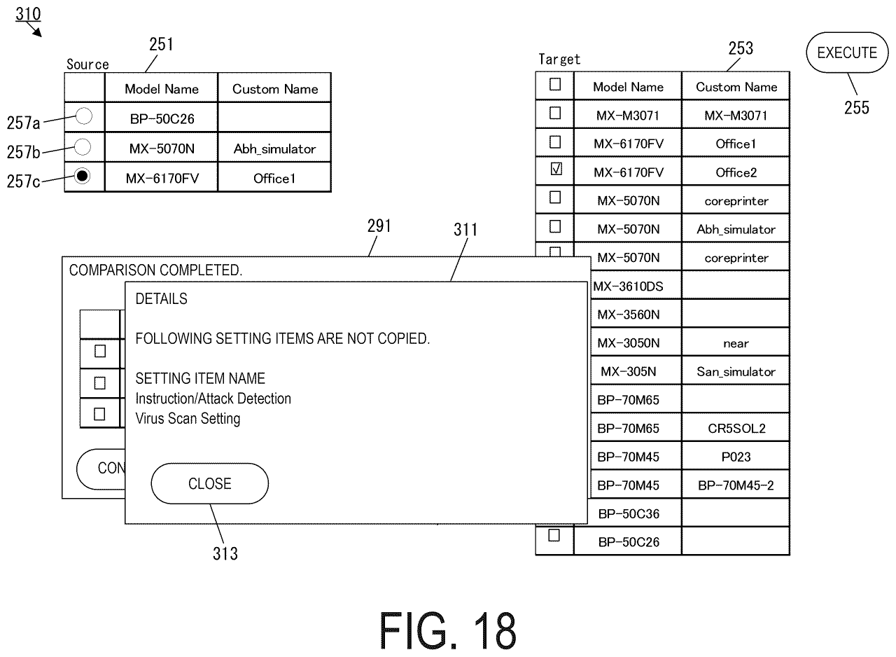

DETAIL buttons 297, 299, and 301 are each a button for displaying detailed information about the comparison result (Compare result) in the row. A screen displayed when the DETAIL button 297, 299, or 301 is operated will be described below with reference to FIG. 18.

The CONTINUE button 293 is a button to cause the screen 340 to transition to a next screen when operated in a state where any of the check boxes 303, 305, and 307 is checked. The CANCEL button 295 is a button for canceling copying of the setting information.

A screen 310 in FIG. 18 is an example of a screen displayed on the client terminal when the setting information is copied between the MFPs of the different models, and is an example of a screen for notifying the user of, among setting items of setting information, a setting item not to be copied, in the first embodiment of the disclosure.

The screen 310 is displayed when the DETAIL button 299 is operated on the screen 290. The screen 310 is obtained by overlaying a dialog 311 on the dialog 291 in the screen 290. The dialog 311 displays a detailed description of the comparison result “Not Compatible” of the model name MX-3050N and a custom name “near” corresponding to the DETAIL button 299.

For the comparison result “Not Compatible”, some setting items of the setting information of the source device are copied to the setting information of the target device. In other words, other setting items of the setting information of the source device are not copied to the setting information of the target device. In the detailed description of the dialog 311, a name “SETTING ITEM NAME” of a setting item that is not copied to the setting information of the target device among the setting items of the setting information of the source device is displayed.

The dialog 311 includes a CLOSE button 313. The CLOSE button 313 is a button for closing the dialog 311. When the CLOSE button 313 is operated, the screen returns to the screen 290.

By viewing the dialog 311, the user can check the setting item that is not copied before the copying is executed, when the setting information of the source device is copied to the target device (MX-3050N) of the model different from that of the source device (MX-6170FV).

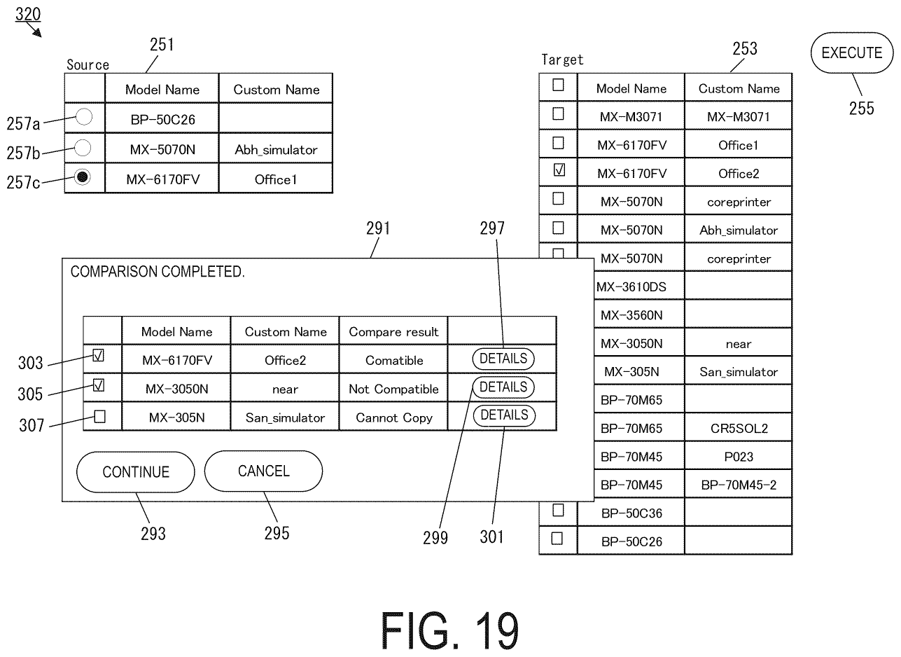

A screen 320 in FIG. 19 is an example of a screen displayed on the client terminal when the setting information is copied between the MFPs of the different models, and is an example of a state in which the target devices are selected, in the first embodiment of the disclosure.

The screen 320 illustrates a state in which the target devices are designated on the screen 290. In this case, the check box 303 is checked to indicate that the MFP having the custom name Office2 of the model identical to that of the source device (custom name Office1) is selected as a copy target. Further, the check box 305 is checked to indicate that the MFP having the model different from that of the source device and having the custom name MX-3050N is selected as a copy target.

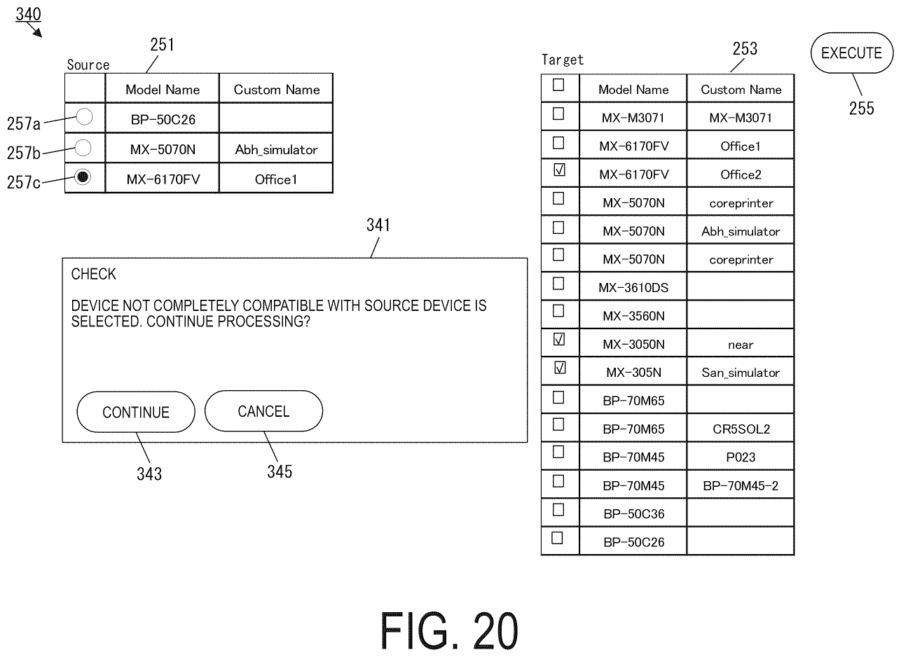

A screen 340 in FIG. 20 is an example of a screen displayed on the client terminal when the setting information is copied between the MFPs of the different models, and is an example of a screen for notifying the user that the selected target devices include a target device that is not completely compatible with the source device, in the first embodiment of the disclosure.

The screen 340 is displayed after the CONTINUE button 293 is operated on the screen 320. The screen 340 is obtained by replacing the dialog 291 in the screen 320 with a dialog 341. The dialog 341 informs the user that the target devices include an MFP having a model different from that of the source device, for confirming whether to execute copying. The CONTINUE button 343 is a button for executing the copying, and a CANCEL button 345 is a button for interrupting the copying.

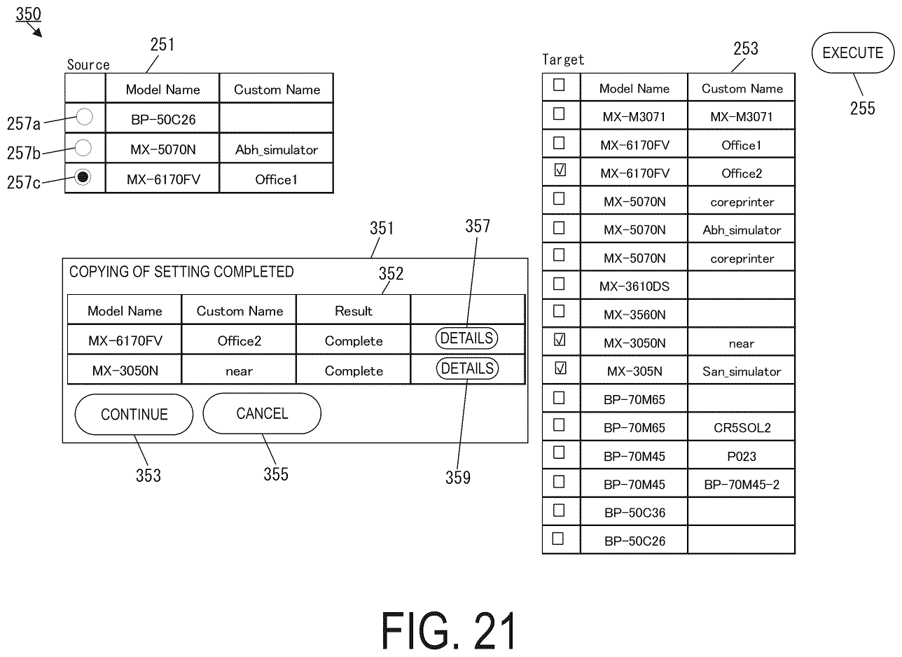

A screen 350 in FIG. 21 is an example of a screen displayed on the client terminal when the setting information is copied between the MFPs of the different models, and is an example of a screen for notifying the user that the copying of the setting information is completed, in the first embodiment of the disclosure.

The screen 350 is displayed after the copying of the setting information is executed by operating the CONTINUE button 343 on the screen 340. The screen 350 is obtained by replacing the dialog 341 in the screen 340 with a dialog 351. The dialog 351 includes a copy result table 352, a CONTINUE button 353, and a CANCEL button 355.

The copy result table 352 is a table in which a result of the copying is displayed for each target device for which the copying is executed. The copy result table 352 includes a model name, a custom name, a result (Result), and DETAIL buttons 357 and 359. A display “Complete” in a result field indicates that the copying of the setting information is completed. When the copying is not completed for some reason, for example, a failure (Failure) is displayed. The DETAIL buttons 357 and 359 are each a button for displaying detailed information about the result of the copying to the corresponding target device. For example, when the DETAIL button 357 or 359 is operated, a list of names of the copied setting items in the setting information of the source device may be displayed.

### 1.6 Effects

According to the first embodiment, the setting information of the source device can be copied as the setting information of the target device not only when the target device is of the model identical to that of the source device but also when the target device is of the model different from that of the source device.

In particular, when the source device and the target device are of the different models, the setting items of the setting information of the source device and the setting items of the setting information of the target device are compared, the setting items in common (common setting items) are extracted, and the setting information including the common setting items is newly generated and can be copied as the setting information of the target device.

In addition, when the source device and the target device are of the different models, the setting items other than the common setting items (non-common setting items) among the setting items included in the setting information of the source device are displayed on the client terminal 5, and thus it is possible to inform the user of the setting items that are not copied.

### 2. Second Embodiment

Next, a second embodiment will be described. In the second embodiment, after the server 3 transmits a copy of setting information to a target device, the server 3 requests the target device to transmit updated setting information. The server 3 compares the setting information transmitted from the own server to the target device with setting information received from the target device, and determines whether the setting information of the target device is normally updated or not. Hereinafter, only parts of a configuration and processing different from the first embodiment will be mainly described.

### 2.1 Copy Failure

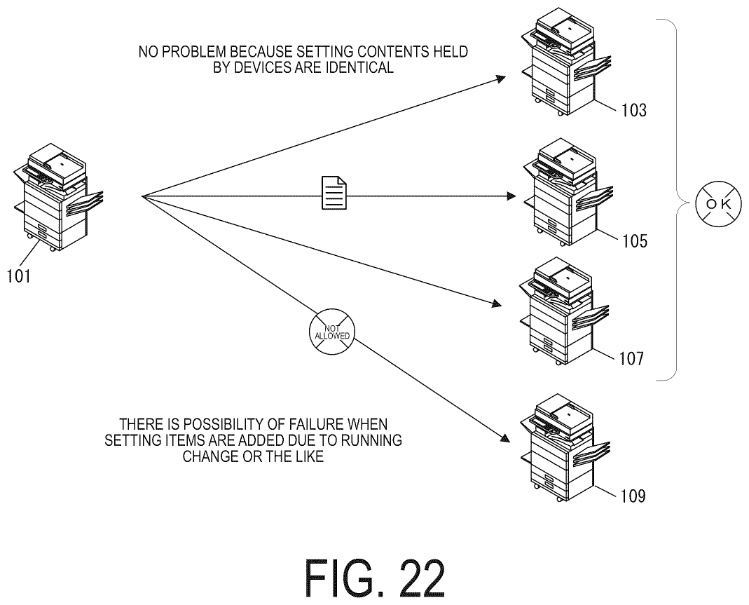

FIG. 22 is a conceptual schematic diagram for describing a failure in copying setting information. MFPs 101 to 109 are MFPs of an identical model. In each of the MFPs 101 to 107, firmware is updated by running change or the like, and new setting items are added to setting information accordingly. Firmware of the MFP 109 is not updated and remains old. Therefore, no new setting item is added to the MFP 109.

At this time, setting information is copied with a source device as the MFP 101 and target devices as the MFPs 103 to 109. When such copying is executed according to the first embodiment, the MFPs 103 to 107 operate normally even after the copying. However, since the setting item added to the setting information of the MFP 101 along with the update of the firmware is not included in setting information of the MFP 109, the MFP 109 does not normally operate after the copying.

Further, regardless of whether the source device and the target device are of an identical model or of different models, there is a risk that the setting information is not completely transmitted due to occurrence of a communication failure or the like when the copied setting information is transmitted from the server 3 to the target device, and as a result, the target device after the copying does not operate normally.

In the second embodiment, in order to prevent such abnormal operation of the target device after the copying, after the copy of the setting information is transmitted from the server 3 to the target device, updated setting information is received from the target device, and whether the update of the setting information is normally executed or not is checked.

### 2.2 Operation

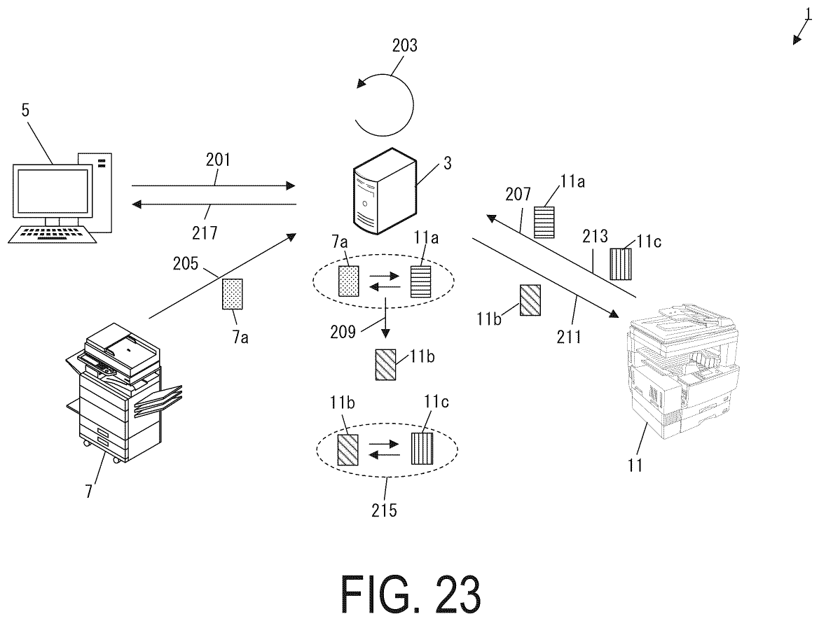

FIG. 23 is a conceptual schematic diagram for describing data processing when setting information is copied between MFPs of different models, and further, whether copying of the setting information succeeds or not is checked. Here, points different from FIG. 13 will be described.

The server 3 transmits the setting information 11b to the MFP 11 as a target device (an arrow 211). The MFP 11 updates setting information of the own device using the received setting information 11b, and transmits updated setting information 11c to the server 3 (an arrow 213). The server 3 compares the setting information 11b transmitted from the own server to the MFP 11 with the setting information 11c received from the MFP 11 (a comparison 215). The server 3 transmits a comparison result to the client terminal 5 (an arrow 217).

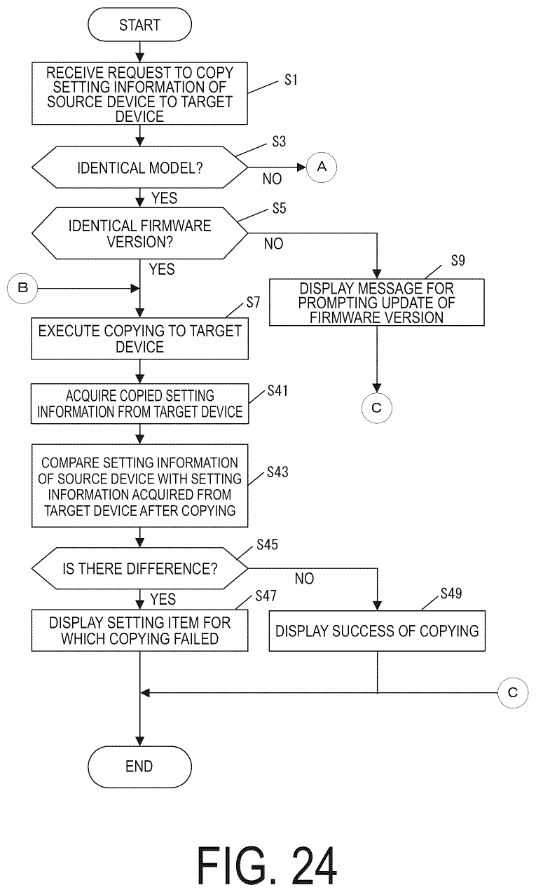

FIG. 24 is a flowchart for describing a part of the operation of the server according to the second embodiment of the disclosure. While the operation in the first embodiment is illustrated in the flowchart in FIGS. 5 and 6, the operation in the second embodiment is illustrated in a flowchart in FIG. 24, which is an alternative to FIG. 5, and in the flowchart of FIG. 6. The flowchart in FIG. 24 differs from the flowchart in FIG. 5 mainly in including steps 41 to 49.

When transmitting setting information and an update instruction of the setting information to a target device in step 7, the controller 31 stores the transmitted setting information in the device information storage unit 91 corresponding to the target device. After the transmission, the controller 31 requests the target device to transmit updated setting information via the communicator 37 and the network NW (this request is also referred to as a setting information transmission request), and receives setting information as a response thereto (step 41). The controller 31 compares the setting information stored in the device information storage unit 91 corresponding to the target device with the setting information received in step 41 to determine presence or absence of a difference (step 43).

When there is a difference (step 45, YES), the controller 31 generates an error message indicating a setting item having a different setting value in the setting information received in step 41 as a setting item for which copying failed, with reference to a setting value of a setting item included in the setting information stored in the device information storage unit 91. The controller 31 transmits the error message to the client terminal 5 via the communicator 37 and the network NW, and the client terminal 5 displays the error message to the user (step 47).

When there is no difference in step 43 (step 45, NO), the controller 31 transmits a message indicating that the copying of the setting information succeeds to the client terminal 5 via the communicator 37 and the network NW, and the client terminal 5 displays the message to the user (step 49).

### 2.3 Effects

According to the second embodiment, copying of setting information can be executed more reliably. In addition, when the copying fails, the user can know a setting item for which the copying failed.

### 3. Third Embodiment

A third embodiment will now be described. In the first embodiment, the user designates an MFP as a target device, and copying of setting information to the designated MFP is executed. However, as described in the first embodiment, for example, an MFP that is of a different model from that of a source device MFP, and has no common setting item in setting information when compared with setting information of the source device MFP cannot be a copy target of the setting information. In the third embodiment, before a target device is designated from among MFPs, it is determined whether all MFPs in the system 1 can be copy targets or not, and a device list including MFPs for which copying can be executed is generated, transmitted to the client terminal 5, and displayed to the user. Hereinafter, only parts of a configuration and processing different from the first embodiment will be mainly described.

### 3.1 Controller 31a

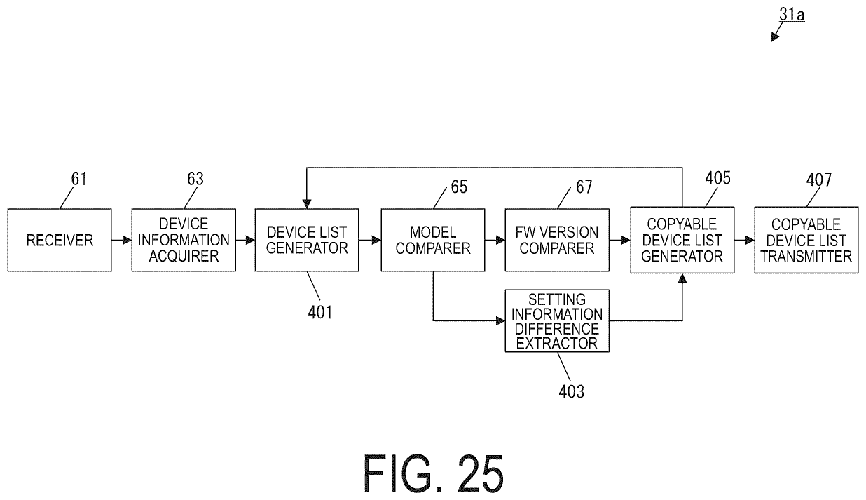

FIG. 25 is a diagram for describing a configuration of a controller 31a of a server according to a third embodiment of the disclosure. In the third embodiment, the controller 31a is used instead of the controller 31 used in the first embodiment. The controller 31a includes a device list generator 401, a setting information difference extractor 403, a copyable device list generator 405, and a copyable device list transmitter 407 as components not included in the controller 31.

The device list generator 401 generates a list of MFPs included in the system 1. The setting information difference extractor 403 extracts a difference between setting information of a source device and setting information of a target device. The copyable device list generator 405 generates a list of MFPs (copyable device list) to which a part or all of the setting information of the MFP designated as the source device can be copied, among the MFPs included in the system 1. The copyable device list transmitter 407 transmits the copyable device list to the client terminal 5 via the communicator 37 and the network NW.

### 3.2 Storage Unit 39a

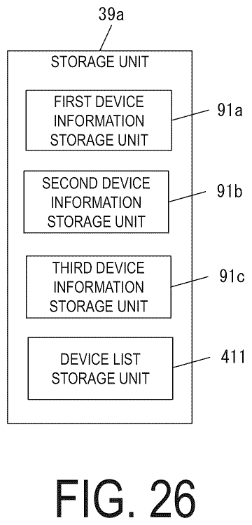

FIG. 26 is a diagram for describing a configuration of a storage unit 39a of the server 3 according to the third embodiment of the disclosure. In the third embodiment, the storage unit 39a is used instead of the storage unit 39 used in the first embodiment. The storage unit 39a includes a device list storage unit 411 in addition to the configuration of the storage unit 39. The device list storage unit 411 stores the device list generated by the device list generator 401. The copyable device list generator 405 generates the copyable device list by updating the device list in the storage unit 39a.

### 3.3 Operation

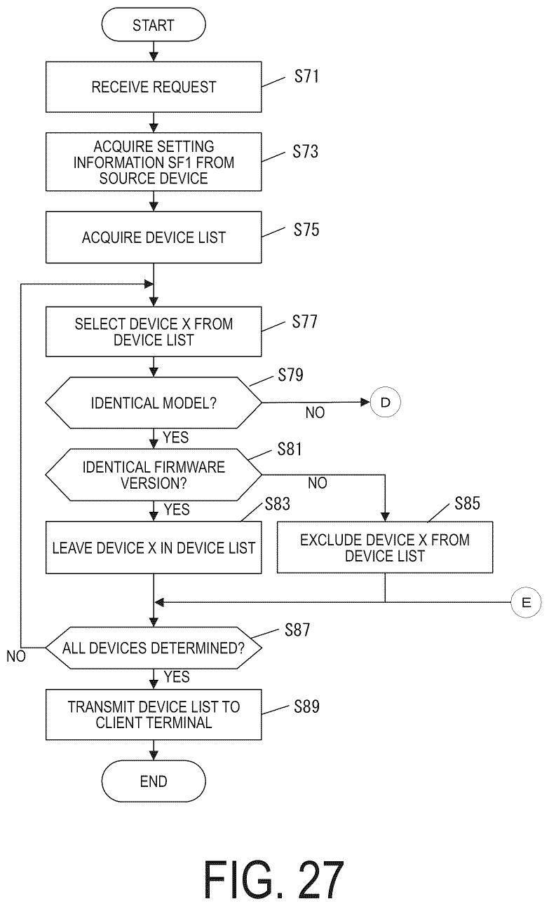

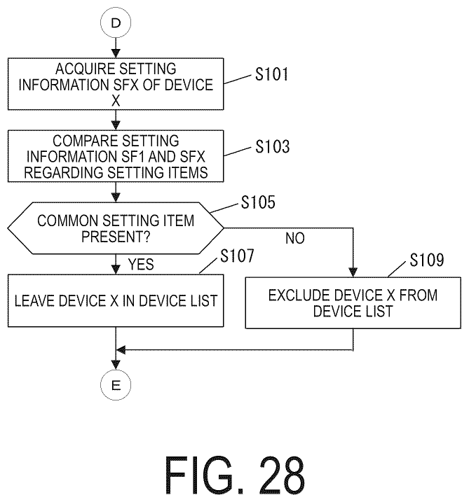

FIG. 27 is a flowchart for describing a part of operation of the server 3 according to the third embodiment of the disclosure. FIG. 28 is a flowchart for describing another part of the operation of the server according to the third embodiment of the disclosure. Although it is preferable that the following processing be appropriately executed by any of the configurations described in FIG. 25, for convenience of description, the following processing will be described as being executed by the controller 31.

The user requests the server 3 to copy setting information from the client terminal 5 via the network NW. At this time, the user designates an MFP to use as a source device from the system 1. The controller 31 receives the request via the network NW and the communicator 37 (step 71), and acquires setting information SF1 of the MFP designated as the source device (step 73). At this time, the controller 31 may request the setting information from the designated MFP via the communicator 37 and the network NW, and receive the setting information. Alternatively, before executing the operation in the flowchart of FIG. 27, the controller 31 may request setting information from each MFP in the system 1, store received setting information in the device information storage unit 91 corresponding to the MFP, and read the setting information from the device information storage unit 91 corresponding to the MFP designated as the source device in step 73.

Next, the controller 31 acquires a device list and stores the device list in the device list storage unit 411 (step 75). The controller 31 may generate the device list by requesting, from all MFPs in the network NW, identification information of the MFPs via the communicator 37 and the network NW. Alternatively, before executing step 71, the controller 31 may request device information from each MFP in the system 1, store received device information in the device information storage unit 91 corresponding to the MFP, and then, from the device information storage units 91 corresponding to MFPs other than the MFP designated as the source device in step 73, read identification information included in device information of the MFPs, to generate the device list.

Next, the controller 31 selects one device from the device list in the device list storage unit 411 (step 77). Hereinafter, the device selected here is referred to as a device X. The controller 31 determines whether the device X is of an identical model to that of the MFP designated as the source device in step 71 or not (step 79). The determination in step 79 is executed in the same manner as in step 3 described above.

When the device X is of an identical model to that of the source device (step 79, YES), the controller 31 determines whether firmware versions of the source device and the device X match or not based on FW version information of each of the source device and the device X read from the device information storage units 91 (step 81).

When the firmware versions match (step 81, YES), the controller 31 leaves the MFP currently selected as the device X in the device list in the device list storage unit 411 (step 83). When the firmware versions do not match (step 81, NO), the controller 31 deletes the MFP currently selected as the device X from the device list in the device list storage unit 411 (step 85).

The controller 31 determines whether the processing between step 77 and step 87 is executed for all the MFPs in the device list or not (step 87). When the processing between step 77 and step 87 is executed for all the MFPs (step 87, YES), the controller 31 transmits the device list in the device list storage unit 411 to the client terminal 5 via the communicator 37 and the network NW (step 89). The client terminal 5 displays received device list on a display device (not illustrated) of the client terminal 5.

In step 87, when there is an MFP for which the processing between step 77 and step 87 is not yet executed (step 87, NO), the controller 31 returns to step 77, selects an MFP that is not yet selected as the device X among the MFPs other than the source device in the system 1 as the device X, and executes step 79 and the subsequent steps.

In step 79, when the device X is of a model different from that of the source device (step 79, NO), the controller 31 acquires setting information of the device X (hereinafter, referred to as setting information SFX) (step 101). The controller 31 may acquire the setting information SFX by requesting the MFP currently selected as the device X to transmit the setting information via the communicator 37 and the network NW. Alternatively, before executing step 71, the controller 31 may request device information from each MFP in the system 1, store received device information in the device information storage unit 91 corresponding to the MFP, and then, from the device information storage units 91 corresponding to MFPs other than the MFP designated as the source device in step 73, read setting information included in the device information of the MFP to acquire the setting information SFX.

The controller 31 compares setting items of the setting information SF1 and setting items of the setting information SFX (step 103). To be more specific, the controller 31 compares the setting items included in the setting information SF1 and the setting items included in the setting information SFX with each other, to classify the setting items included in the setting information SF1 into two types of common setting items and non-common setting items. The common setting item is a setting item included in the setting information SF1 of the source device and the setting information SFX of the target device in common. The non-common setting item is a setting item that is included only in the setting information SF1 of the source device and is not included in the setting information SFX of the target device. The controller 31 extracts the common setting items from the setting information SF1.

When there is a common setting item (step 105, YES), the controller 31 leaves the device X in the device list in the device list storage unit 411 (step 107). When there is no common setting item (step 105, NO), the controller 31 deletes the device X from the device list in the device list storage unit 411 (step 109).

### 3.4 Operation Example

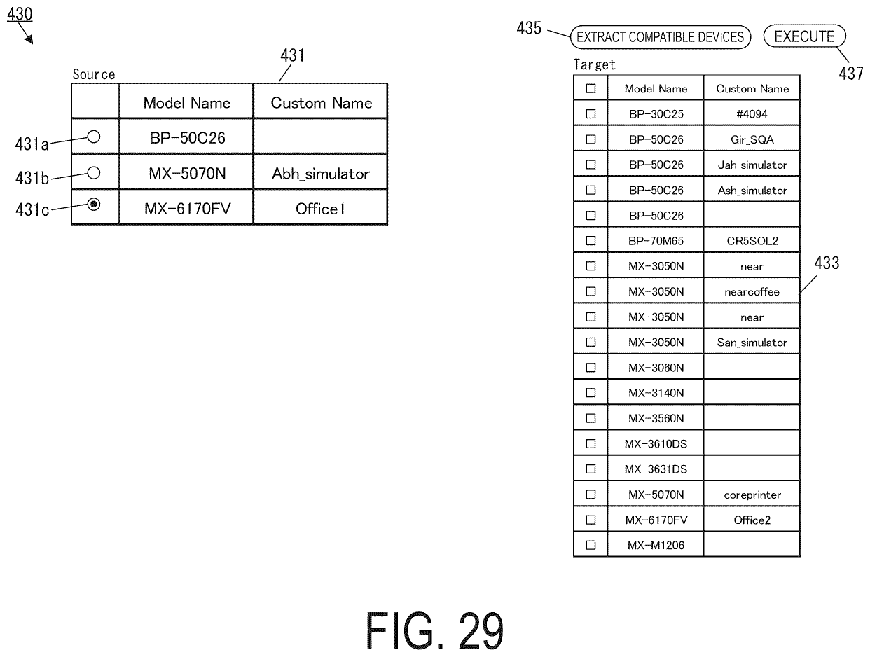

A screen 430 in FIG. 29 is an example of a screen displayed on the client terminal 5, and is an example of a screen for selecting a source device, in the third embodiment of the disclosure. The screen 430 includes a source table 431, a target table 433, an EXTRACT COMPATIBLE DEVICE button 435, and an EXECUTE button 437.

The source table 431 is a table in which candidates of an MFP to be a source device among the MFPs of the system 1. The source table 431 includes radio buttons 431a, 431b, and 431c, and an MFP to be the source device is designated by turning on or off these radio buttons. In the drawing, the MFP with the model name MX-6170FV and the custom name Office1 is selected as the source device.

The target table 433 is a table in which candidates of an MFP to be a target device among the MFPs of the system 1 are displayed. Each row of the target table 433 includes a check box, a model name, and a custom name.

When the EXTRACT COMPATIBLE DEVICE button 435 is operated in a state where the MFP to be the source device is designated, the controller 31 extracts an identical model (a model having an identical model name, or a model having a different model name but an identical series, that is, a model having a different model name but an identical combination of setting items included in setting information) to that of the MFP designated as the source device from MFPs in the target table 433, and generates a comparison result table 492 described below. More specifically, the operation described with reference to the flowcharts in FIGS. 27 and 28 is started with the MFPs in the target table 433 as targets. When the EXTRACT COMPATIBLE DEVICE button 435 is operated in the state of FIG. 29, the controller 31 executes the above-described operation with the MFP having the model name MX-6170FV and the custom name Office1 as the source device. Note that the comparison result table 492 may be generated by extracting an MFP having different model name and series but some overlapping setting items included in setting information, in addition to the model identical to that of the MFP designated as the source device.

The EXECUTE button 437 is a button for starting execution of copying of setting information with the MFP designated in the source table 431 as the source device and the MFP designated in the target table 433 as the target device.

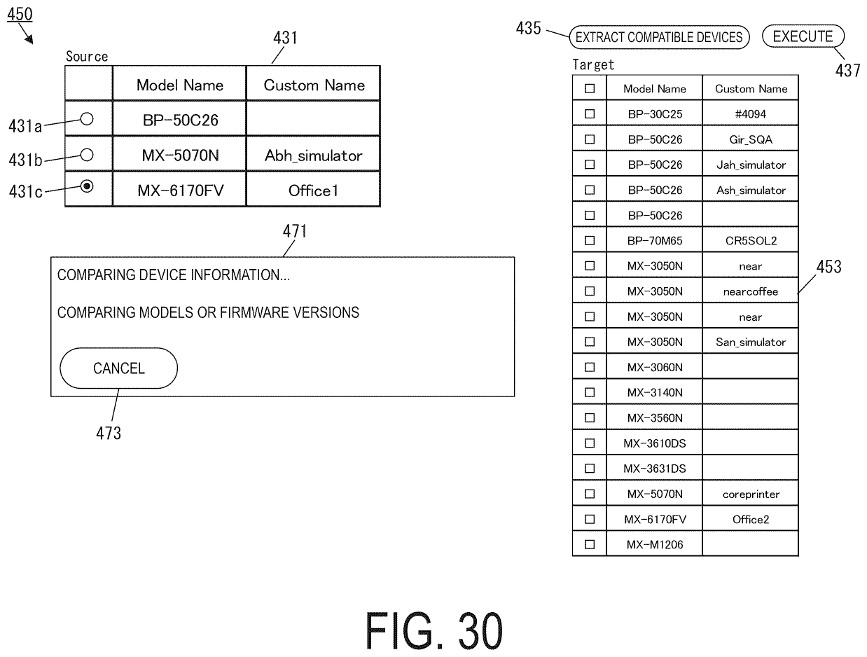

A screen 450 in FIG. 30 is an example of a screen displayed on the client terminal 5, and is an example of a screen displayed when device information of the source device and device information of each MFP in the target table are compared, in the third embodiment of the disclosure.

The screen 450 is displayed in response to an operation on the EXTRACT COMPATIBLE DEVICE button 435 on the screen 430. The screen 450 is obtained by adding a dialog 471 to the screen 430. The dialog 471 displays a message for notifying the user of the client terminal 5 that a device information comparison is being executed. The dialog 471 includes a CANCEL button 473. The CANCEL button 473 is a button for interrupting the device information comparison.

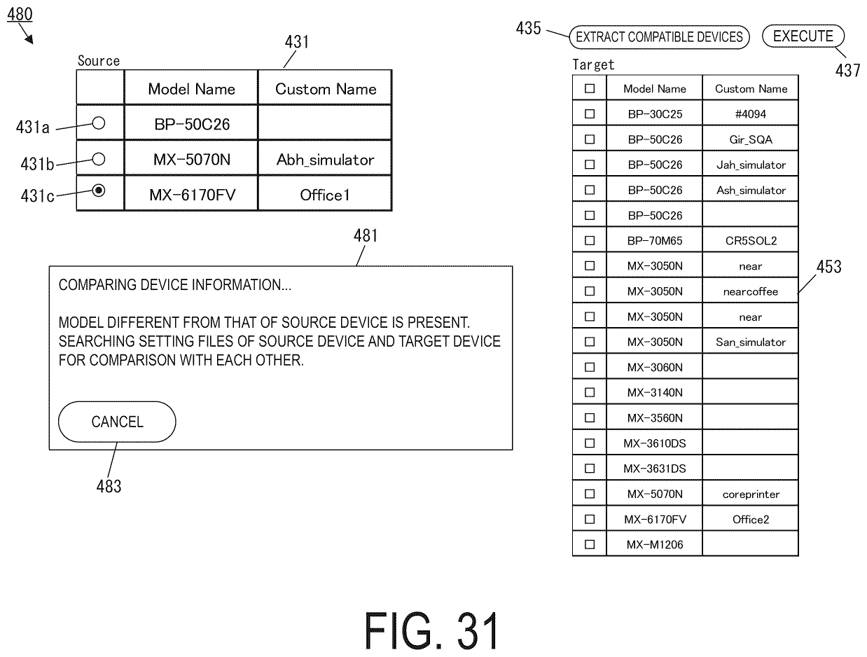

A screen 480 in FIG. 31 is an example of a screen displayed on the client terminal 5, and is an example of a screen for notifying the user that candidate devices for the target device include a candidate device not completely compatible with the source device, in the third embodiment of the disclosure.

After the screen 450 is displayed and the device information comparison advances, the screen 480 is displayed. The screen 480 includes a dialog 481. When detecting a model different from that of the MFP designated as the source device in the source table 431 from among MFPs in a target table 453, the controller 31 displays the dialog 481 instead of the dialog 471. The dialog 481 displays a message for notifying that a model different from that of the source device is detected in the target table 453. Further, the dialog 481 displays a message indicating that the source device and the target device are being compared regarding setting information to determine whether there is a common setting item or not. The dialog 481 includes a CANCEL button 483. The CANCEL button 483 is a button for interrupting the device information comparison.

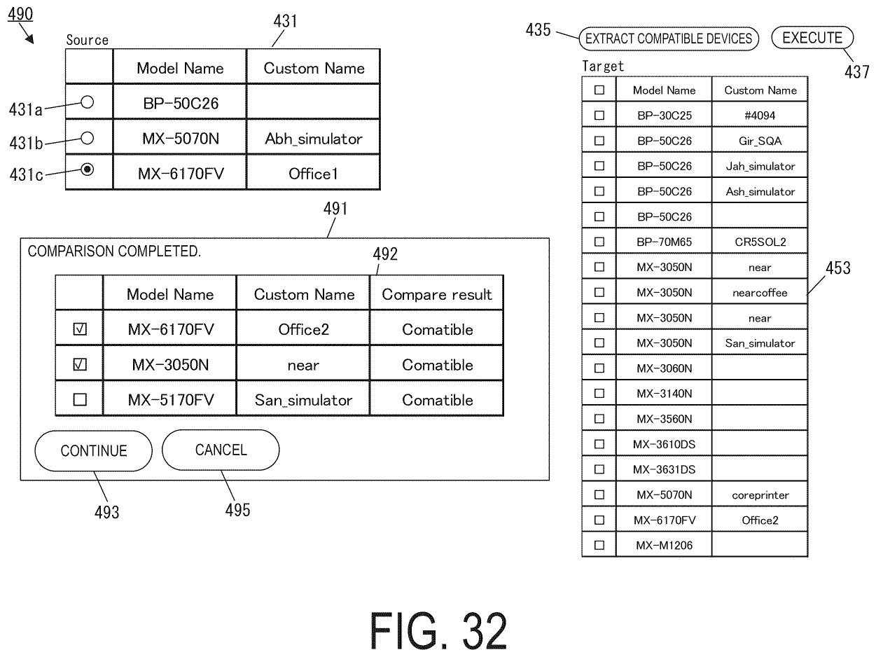

A screen 490 in FIG. 32 is an example of a screen displayed on the client terminal 5, and is an example of a screen for notifying the user that the candidate devices for the target device include a candidate device not completely compatible with the source device, in the third embodiment of the disclosure.

After the screen 480 is displayed and the setting information comparison between the source device and the target device is completed, the screen 490 is displayed. When the setting information comparison between the source device and the target device is completed, the controller 31 displays a dialog 491 instead of the dialog 481. The dialog 491 includes a comparison result table 492, a CONTINUE button 493, and a CANCEL button 495.

The comparison result table 492 is a table that stores, among the MFPs in the target table 453, an MFP of a model identical to that of the MFP being the source device and an MFP of a different model but having compatible setting information. Each row of the comparison result table 492 includes a check box, a model name, a custom name, and a comparison result. The check box is used to designate a target device for which copying of setting information is to be executed. The CONTINUE button 493 is a button for starting copying of setting information with an MFP in a row with a checked box in the comparison result table 492 as a target device. The CANCEL button 495 is a button for ending the processing without executing copying of setting information.

A meaning of a value of “Compare result” in the comparison result table 492 is the same as that in FIG. 17. “MX-6170FV”, “MX-3050N”, and “MX-5170FV” are different in “Model Name” from each other, but have an identical configuration of setting information, and thus are determined to be of a model identical (Compatible) to that of “MX-6170FV” indicated by the radio button 431c in the source table 431.

In the case of FIG. 32, when the CONTINUE button 493 is operated, copying of setting information is executed with the following MFPs as the source device and the target devices. The source device: the MFP with a model name MX-6170FV and a custom name Office1 corresponding to a row of the radio button 431c in the source table 431.

The target devices: an MFP with a model name MX-6170FV and a custom name Office2 and an MFP with a model name MX-3050N and a custom name “near” in the comparison result table 492.

### 3.5 Effects

According to the third embodiment, when an MFP to be a source device is designated, a list of MFPs to which setting information of the source MFP can be copied can be displayed.

### 4. Variations

The disclosure is not limited to the embodiments and variations described above, and various variations are possible. In other words, the technical scope of the disclosure also includes embodiments obtained by combining technical means that are appropriately modified within the scope of the gist of the disclosure.

In the above-described embodiments, the server 3 is described as a device different from an MFP, but an MFP may incorporate the server 3 and operate as the server 3. In this case, the MFP includes a controller and a communicator capable of communicating with other MFPs, and the controller compares a model of the own MFP with models of the other MFPs with each other, determines whether a common setting item exists in both of the own MFP and setting information of the other MFPs in common when the own MFP and the other MFPs are of models different from each other, and outputs information related to copying a part or all of the setting information of the own MFP as the setting information of the other MFPs based on a result of the determination.

The programs running on each device in the embodiments are programs for controlling a CPU or the like (programs for causing a computer to function) to enable the aforementioned functions in the embodiments. Information handled by such a device is temporarily stored in a temporary storage device (for example, a RAM) during processing and then stored in various storage devices such as read only memories (ROMs) and HDDs, and is read, modified, and written by the CPU as necessary.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Further, not only are the functions of the above-described embodiments enabled by executing the loaded program, but the functions of the disclosure may also be enabled by processing in cooperation with an operating system or another application program or the like, based on instructions from the program.

In a case where the programs are distributed to the market, the programs can be stored and distributed in a portable recording medium, or can be transferred to a server computer connected via a network such as the Internet. In this case, it is obvious that a storage device of the server computer is also included in the disclosure.

1. An information processing apparatus, comprising:
a controller; and
a communicator allowed to communicate with a plurality of devices including a first device and a second device, wherein
the controller
compares a model of the first device and a model of the second device with each other,
determines whether a common setting item exists in both of the first device and setting information of the second device in common in a case where the first device and the second device are different from each other in model, and
outputs information related to copying a part or all of the setting information of the first device as the setting information of the second device based on a result of the determination.

2. The information processing apparatus according to claim 1, wherein
the controller further
extracts a setting value of the common setting item from the setting information of the first device, and
executes copying of the extracted setting value as the setting information of the second device.

3. The information processing apparatus according to claim 2, wherein
the controller further,
in a case where the first device and the second device are of an identical model, compares both with each other regarding firmware version, and
in a case where both are identical regarding firmware version, copies an entirety of the setting information of the first device as the setting information of the second device.

4. The information processing apparatus according to claim 2, wherein
the controller further,
after transmitting the setting information of the second device for which the copying is to be executed to the second device, transmits a setting information transmission request that requests transmission of setting information to the second device,
receives setting information transmitted from the second device in response to the setting information transmission request, and
determines whether the copying is successful or not based on a comparison result between the setting information of the first device and the setting information received from the second device.

5. The information processing apparatus according to claim 1, wherein
with each of the plurality of devices as the second device, presence or absence of the common setting item is determined,
based on a result of the determination, a device list including a device to which a part or all of the setting information of the first device is copyable among the plurality of devices is generated.

6. The information processing apparatus according to claim 1, wherein
based on the result of the determination, the controller causes a display device of another information processing apparatus connected via the communicator to display a screen related to the result.

7. The information processing apparatus according to claim 1, wherein
the controller
receives a selection of the first device, and
causes a display device of another information processing apparatus connected via the communicator to display the second device according to the selected first device.

8. The information processing apparatus according to claim 1, wherein
the controller causes a display device of another information processing apparatus connected via the communicator to display the second device extracted according to a comparison result with the selected first device.

9. An image forming apparatus, comprising:
a controller; and
a communicator allowed to communicate with another image forming apparatus, wherein
the controller
compares a model of the own image forming apparatus and a model of the other image forming apparatus with each other,
determines whether a common setting item exists in both of the own image forming apparatus and setting information of the other image forming apparatus in common in a case where the own image forming apparatus and the other image forming apparatus are different from each other in model, and
outputs information related to copying a part or all of the setting information of the own image forming apparatus as the setting information of the other image forming apparatus based on a result of the determination.

10. An information processing system, comprising:
a client terminal, a server, and a plurality of image forming apparatuses including a first image forming apparatus and a second image forming apparatus, that are communicably connected to each other via a network, wherein
the server
compares a model of the first image forming apparatus and a model of the second image forming apparatus with each other,
determines whether a common setting item exists in both of the first image forming apparatus and setting information of the second image forming apparatus in common in a case where the first image forming apparatus and the second image forming apparatus are different from each other in model, and
outputs, to the client terminal, information related to copying a part or all of the setting information of the first image forming apparatus as the setting information of the second image forming apparatus based on a result of the determination.
